(19) United States
(12) Patent Application Publication
(10) Pub. No.: US 2025/0278550 A1
(43) Pub. Date: Sep. 4, 2025

(54) TOPIC-CONDITIONAL EXTRACTIVE SUMMARIZATION

(71) Applicant: MICROSOFT TECHNOLOGY LICENSING, LLC., REDMOND, WA (US)

(72) Inventors: JONATHAN EPHRATH, HERZILYA (IL); SHAHAR ZVI KEREN, HEMED (IL); NOAM KOENIGSTEIN, TEL AVIV (IL); ITZIK MALKIEL, RAMAT GAN (IL); NIR NICE, SALIT (IL); YAKIR YEHUDA, TIRAT CARMEL (IL)

(21) Appl. No.: 18/668,206

(22) Filed: May 19, 2024

Related U.S. Application Data
(60) Provisional application No. 63/560,755, filed on Mar. 3, 2024.

(51) Int. Cl. G06F 40/166; G06F 40/289

(52) U.S. Cl. CPC G06F 40/166; G06F 40/289

(57) ABSTRACT

A topic-conditional extractive summarization system identifies the most pertinent sentences in a document for use in a topic summarization. The system utilizes a neural encoder model to generate clusters of similar sentence embeddings for each topic and associated anchors, without ground truth summaries. A graph is generated for each topic, representing the document, and contains a node for each sentence in the document. The edges that connect two sentences contain an edge weight containing a sentence embedding similarity factor and a sentence-topic anchor similarity factor for each connected node. The importance of a sentence for a particular topic is identified by computing a score for each node in a graph that is based on the edge weights of the nodes connected to a particular node.

### CROSS-REFERENCE TO RELATED APPLICATIONS

The present application claims the benefit of the earlier filed provisional application having Ser. No. 63/560,755 filed on Mar. 3, 2024, which is incorporated by reference in its entirety.

### BACKGROUND

Automatic text summarization aims to generate a concise summary of the key information within a document. Abstractive summarization is one type of automatic text summarization technique that generates novel sentences from information extracted from the document. Abstractive summarization techniques often utilize sequence-to-sequence models to generate a summarization of the document. However, the input to the sequence-to-sequence model is limited to the size of a context window that the model uses to generate the summarization. The context window size is often constrained to a limited number of tokens that the model can process at one time. However, for lengthy documents the limitation on the size of the context window affects the accuracy of the summarization that can be generated by the model.

### SUMMARY

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

A topic-conditional extractive summarization system identifies the most pertinent sentences in a document to extract for use in a topic summarization. The technique described herein learns to identify sentences relevant to a topic based on the similarity of sentences in documents known to be associated with a topic. The technique uses an unsupervised approach where the sentence similarities are learned without ground truth summaries.

The similarity between the various sentences of a document is determined through similar sentence embeddings and a sentence-topic anchor alignment similarity. The sentence embeddings are generated from a neural encoder model fine-tuned using contrastive learning on positive and negative samples to learn the anchors for each topic. The sentence-topic anchor alignment similarity indicates the likelihood of a sentence being relevant to an anchor of a topic.

A graph representing the document is generated for each topic. The graph contains a node for each sentence in the document and an edge between two nodes or sentences contains an edge weight that represents the similarity between the two connected sentences. A graph-based ranking technique is the used to assign a score to each node in each graph which includes the edge weights of neighboring nodes to determine the importance of each sentence to a topic. The sentences having the highest scores for a topic are used in the topic summarization for that topic.

These and other features and advantages will be apparent from a reading of the following detailed description and a review of the associated drawings. It is to be understood that both the foregoing general description and the following detailed description are explanatory only and are not restrictive of aspects as claimed.

### BRIEF DESCRIPTION OF DRAWINGS

FIG. 1 is a schematic diagram illustrating an exemplary natural language text document and the corresponding topic summaries automatically generated by the topic-conditional extractive summarization system.

FIG. 2 is a schematic diagram illustrating exemplary components of the topic-conditional extractive summarization system.

FIG. 3 is a flow diagram illustrating an exemplary method for generating a topic summary using the techniques and components of the topic-conditional extractive summarization system.

FIG. 4 is a schematic diagram illustrating an exemplary deep learning model configured as a neural encoder transformer model with attention to generate sentence feature vectors and topic anchors.

FIG. 5 is a schematic diagram illustrating an exemplary edge weight computation.

FIG. 6 is a schematic diagram illustrating exemplary applications of the topic-conditional extractive summarization system.

FIG. 7 is a block diagram illustrating a first exemplary operating environment of the topic-conditional extractive summarization system.

FIG. 8 depicts the performance improvements of the topic-conditional summarization system.

FIG. 9 is a schematic diagram illustrating a second exemplary operating environment and method of the topic-conditional extractive summarization system.

### DETAILED DESCRIPTION

### Overview

Aspects of the present disclosure pertain to topic-conditional extractive summarization where summaries of a document are produced automatically for pre-defined topics. Extractive summarization creates a summary of a topic by extracting the most pertinent sentences from a document without modifying those sentences.

Extractive summarization differs from abstractive summarization and query-based summarization methods. Abstractive summarization employs generative models (i.e., sequence-to-sequence models) to produce a summary from novel sentences not extracted from the document. The generative models suffer from a context-size restraint which limits the use of the generative models for lengthy documents. In addition, a generative model may suffer from hallucinations where the model produces inaccurate summaries containing misleading and erroneous data.

Query-based summarization methods generate summaries that answer specific user queries. The question guides the method through the summarization process and may yield a summary having a mixture of topics and themes that are not pertinent to a topic of interest.

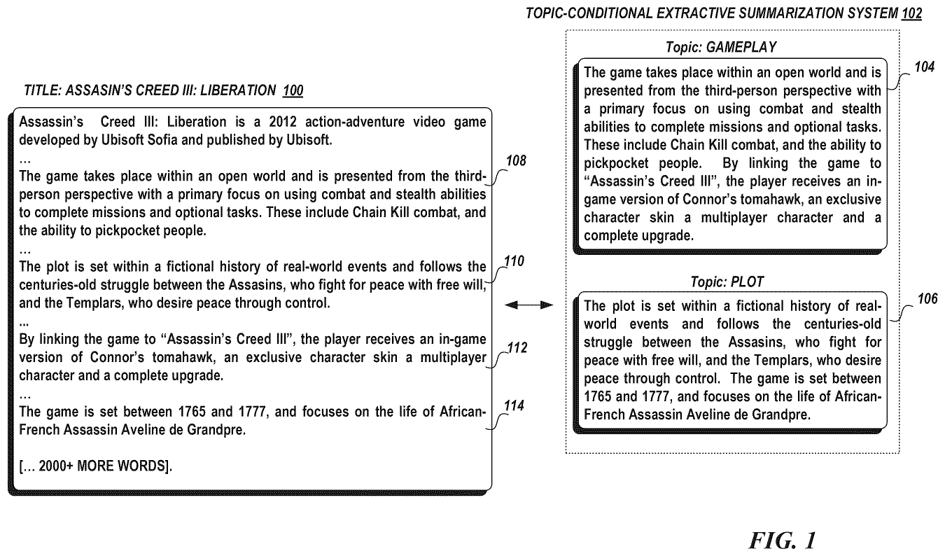

Turning to FIG. 1, there is shown an exemplary natural language text consisting of the Wikipedia article on “Assassin's Creed III: Liberation” which is a lengthy document having over approximately 2591 words. The document 100 is associated with two topics, Gameplay 104, and Plot 106. The topic-conditional extractive summarization system 102 produces a summarization for each topic 104, 106 using specific sentences from the Wikipedia article. For example, as shown in FIG. 1, the sentences 108, 112 are extracted from the document 100 and are included in the Gameplay topic summary 104. Sentences 110, 114 are extracted from the document 100 and included in the Plot topic summary 106. A topic summary needs to contain sentences that are relevant to a topic with low redundancy and in a manner where the summary is readable and coherent. In order to achieve these characteristics, it is important to more accurately identify the most important sentences that relate to a topic.

The topic-conditional extractive summarization system uses a deep learning model and a graph-based ranking method to identify the sentences in the document pertinent to a topic. The deep learning model is trained to generate a sentence embedding space where semantically-similar sentences of a topic have close embeddings. Clusters of semantically-similar sentence embeddings for each topic are formed with each cluster having an anchor representing the center of a cluster.

A graph-based ranking method is used to rank the importance of the sentences in the document with respect to each topic. Initially, a graph for each topic is generated to represent the document where a node of the graph represents a sentence and an edge between two nodes contains an edge weight that represents the similarity between the two connected nodes in terms of sentence embedding similarity, sentence-topic alignment and cluster size normalization.

The graph-based ranking method then uses the scores of its neighboring connected nodes, and the edge weights of its neighboring connected nodes to associate the importance of the node's sentence to each topic. The top-k highest scoring sentences for a topic are then selected for the topic's summary and then output in the order these sentences appear in the document.

The technique described herein computes a score for each sentence for each topic which results in a more accurate identification of the most pertinent sentences for a given topic. If the technique produced a score for a sentence based on a single topic, the technique would not consider how a sentence relates to another topic. For instance, sentence X might correlate to topic A but have higher scores with sentences that are correlated to topic B. If the sentence scores were calculated using the graph for topic A only, then the technique would miss that sentence X is related more with topic B than topic A.

Attention now turns to a more detailed description of the components, methods, processes, and system for automating topic summarization of a long document.

### System

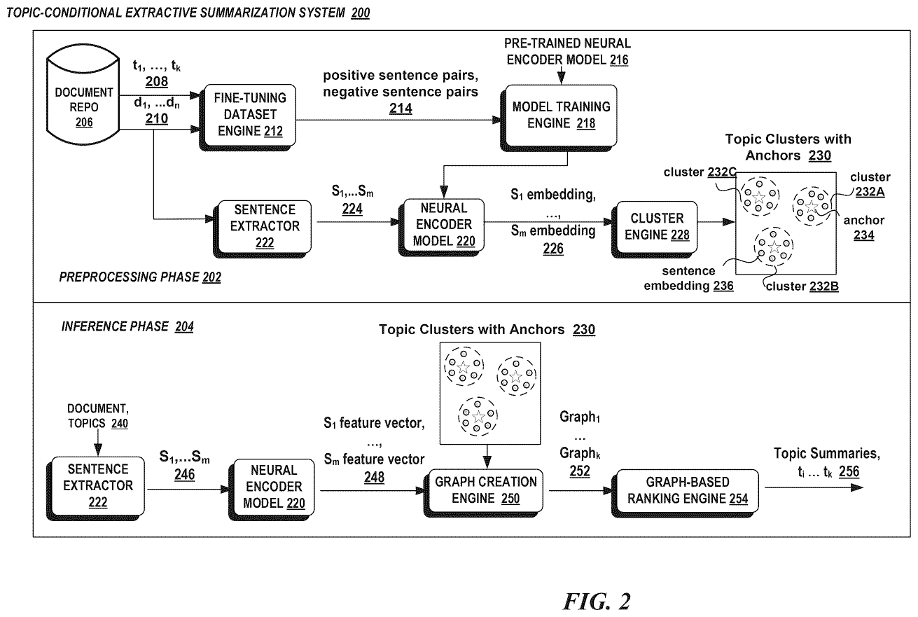

FIG. 2 illustrates a block diagram of an exemplary topic-conditional extractive summarization system 200. In an aspect, the topic-conditional extractive summarization system consists of a pre-processing phase 202 and an inference phase 204.

In the pre-processing phase 202, a deep learning model, such as a neural encoder model 220, is trained to generate feature vectors for sentences associated with a particular topic from a list of topics, T={t₁, . . . , tₖ} 208. The model training engine 218 obtains a neural encoder model pre-trained on natural language text 212 and fine-tunes the pre-trained neural encoder model on paired sentences from a collection of documents, D={d₁, . . . , dₙ}, 210, extracted from a document repository (repo) 206. Each document consists of a set of paragraphs and each paragraph contains one or more sentences, S₁, . . . . Sₘ. Each topic, tᵢ, is related to a given collection of paragraphs, Pⁱ={p₁, . . . , p_{qi}}, where qi denotes the number of paragraphs associated with topic tᵢ.

The fine-tuning dataset engine 212 generates a fine-tuning dataset consisting of positive sentence pairs and negative sentence pairs 214. A positive sentence pair consists of two sentences from the same paragraph of a given document, where the sentences are associated with the same topic. A negative sentence pair consists of two sentences from different documents. The model training engine 218 uses the positive and negative sentence pairs to produce an embedding space where the embeddings of semantically-similar sentences are close to one another while semantically-dissimilar sentences are far apart.

An embedding is a vector of floating-point numbers. A token embedding represents a token and a sentence embedding represents a sentence of a document. A token represents a portion of the text in a document such as character or word. The terms feature vector and sentence embedding are used interchangeably.

Once the neural encoder model 220 is trained, the model 220 is used to generate clusters of semantically-similar sentence feature vectors and their associated anchors 230. A sentence extractor 222 partitions each paragraph of each document 210 into sentences 224 which are input into the neural encoder model 220 to generate a sentence feature vector for each sentence of the paragraph.

In an aspect, the Density-Based Spatial Clustering of Applications with Noise (DBSCAN) method is used to form the clusters 232A-232C and to compute an anchor 234 for each cluster. The DBSCAN method is best for clusters that contain irregularities and noise. The anchor represents the center of the cluster. There may be several clusters for a topic. Alternatively, the clusters and associated anchors may be formed using other clustering algorithms, such as, k-means clustering, mean-shift clustering, Gaussian Mixture Models (GMM) clustering and the like.

In the inference phase 204, a topic summary 256 is generated for each topic in a given document 240. The sentence extractor 222 partitions the given document into sentences 246 and each sentence is input into the neural encoder model 220 to generate a respective sentence feature vector 248.

A graph creation engine 250 generates a graph, Graph₁ . . . , Graphₖ, for each topic 252 using the topic clusters and anchors 230. A graph Graphᵢ is a directed graph for topic i with a set of nodes N and a set of edges E. Each node represents a sentence in the document and each edge, W_{qp}, contains an edge weight. The edge weight represents the similarity between the two sentences of the connected nodes based on their respective sentence feature vectors and the similarity between each sentence and the anchors of the topic, normalized by the cluster size. The edge weight consists of three scores as follows:

$${w}_{q , p} = C ( SE ( q ) ) , SE ( p ) ) * A ( q , {t}_{i} ) * A ( p , {t}_{i} ) , \qquad ( 1 )$$

where C (SE (q)), SE (p)) represents the sentence embedding similarity between the two connected nodes,

A(q, tᵢ) is the probability of the sentence associated with node q associated with topic tᵢ, based on the sentence-topic similarity function,

A(p, tᵢ) is the probability of the sentence associated with node p associated with topic tᵢ based on the sentence-topic similarity function,

SE (q) is the feature vector for sentence q output from the neural encoder model,

SE(p) is the feature vector for sentence p output from the neural encoder model,

C is the cosine similarity function, and

tᵢ is the given topic.

The sentence-topic similarity function is defined for a general sentence s and topic

$${t}_{i} as A ( s , {t}_{i} ) := \frac{{e}^{z ( s , {t}_{i} )}}{{\sum }_{j = 1}^{k} {e}^{z ( s , {t}_{i} )}} , \qquad ( 2 )$$

$$where z ( s , {t}_{i} ) is = {max}_{1 \leq r \leq {l}^{i}} ( NRM ( \overline{{a}_{r}^{ι}} ) * C ( SE ( s ) , {a}_{r}^{i} ) ) , \qquad ( 3 )$$

where a̅ᵣ̅^̅{̅l̅}̅ denotes the size of the cluster of sentences associated with the anchor aᵣⁱ of topic i,

NRM is the z-score normalization applied to the cluster size of an anchor of the topic i, and

$$\frac{{e}^{z ( s , {t}_{i} )}}{{\sum }_{j = 1}^{k} {e}^{z ( s , {t}_{i} )}}$$

is the softmax function applied to z (s, tᵢ).

The sentence-topic similarity function represents the similarity between each sentence and the given topic by computing a score, for each anchor of the topic, that includes the cosine similarity of the sentence embedding of a node with the anchor, normalized by the cluster size of the anchor. The maximum score, overall the scores, for each anchor of the topic is selected as the lead score for the node. The final sentence-topic similarity score for the node and the topic is determined by applying the softmax function across all lead scores from all topics, which transforms the final sentence-topic similarity score for a sentence into a probability.

A graph-based ranking engine 254 uses each graph to rank the importance of each sentence to each topic by associating a score with each node. In an aspect, the score for each node is determined from the scores of its connected neighbor nodes and the edge weights of the connected neighbor nodes. The sentences in the nodes having the top-k highest scores for a particular topic are selected for the topic summary of that topic.

### Methods

Attention now turns to a more detailed description of the methods used in the system for topic-conditional extractive summarization. It may be appreciated that the representative methods do not necessarily have to be executed in the order presented, or in any particular order, unless otherwise indicated. Moreover, various activities described with respect to the methods can be executed in serial or parallel fashion, or any combination of serial and parallel operations. In one or more aspects, the method illustrates operations for the systems and devices disclosed herein.

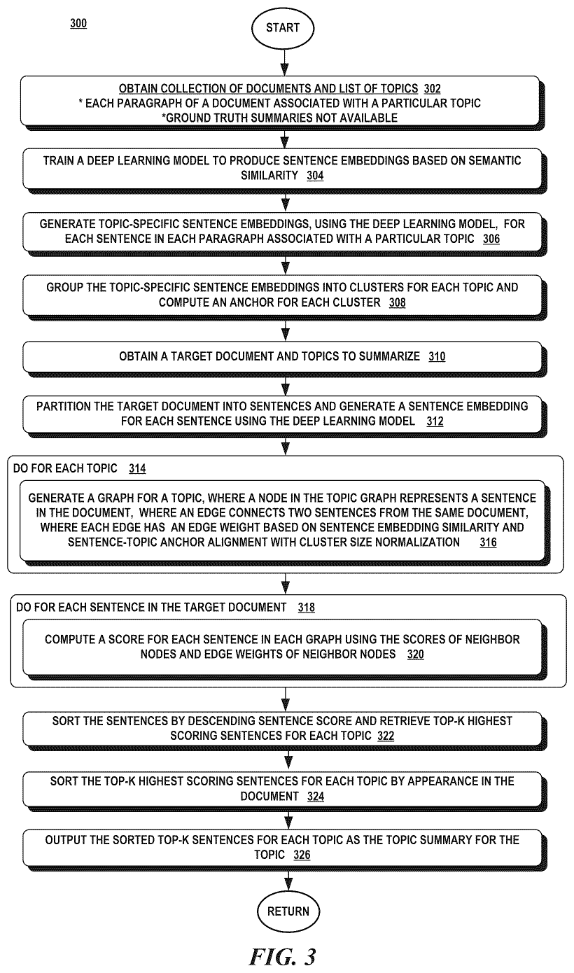

Turning to FIG. 3, there is an exemplary method for topic-conditional extractive summarization 300. Initially, a collection of documents and a list of topics are obtained (block 302).

Next, the neural encoder model is trained to learn to generate sentence embeddings for the sentences in the collection of documents with respect to the list of topics (block 304). In an aspect, the neural encoder model is configured as a neural encoder transformer model with attention. A neural transformer model with attention is one distinct type of machine learning model. Machine learning pertains to the use and development of computer systems that are able to learn and adapt without following explicit instructions by using algorithms and statistical models to analyze and draw inferences from patterns in data. Machine learning uses different types of statistical methods to learn from data and to predict future decisions. Traditional machine learning includes classification models, data mining, Bayesian networks, Markov models, clustering, and visual data mapping.

Deep learning differs from traditional machine learning since it uses multiple stages of data processing through many hidden layers of a neural network to learn and interpret the features and the relationships between the features. Deep learning embodies neural networks which differs from the traditional machine learning techniques that do not use neural networks. Neural transformers models are one type of deep learning that utilizes an attention mechanism. Attention directs the neural network to focus on a subset of features or tokens in an input sequence thereby learning different representations from the different positions of the tokens in an input sequence. The neural transformer model handles dependencies between its input and output with attention and without using recurrent neural networks (RNN) (e.g., long short-term memory (LSTM) network) and convolutional neural networks (CNN). Examples of a neural encoder transformer model with attention include the Bi-directional Encoder Representations (BERT) model, OpenAI's embedding model, Robustly Optimized BERT PreTraining Approach (RoBERTa), A Lite BERT (ALBERT), DistilBERT, Enhanced Representation through kNowledge Integration (ERNIE), XLNet, ELECTRA, etc.

The neural encoder model is trained for a similarity ranking task by fine-tuning a pre-trained neural encoder model, such as the BERT model, with a self-supervised training dataset of sentence pairs. At the end of the training, the model produces a domain-specific language model that is optimized for the semantics and taxonomy of a given document so that the model produces improved sentence similarity accuracy.

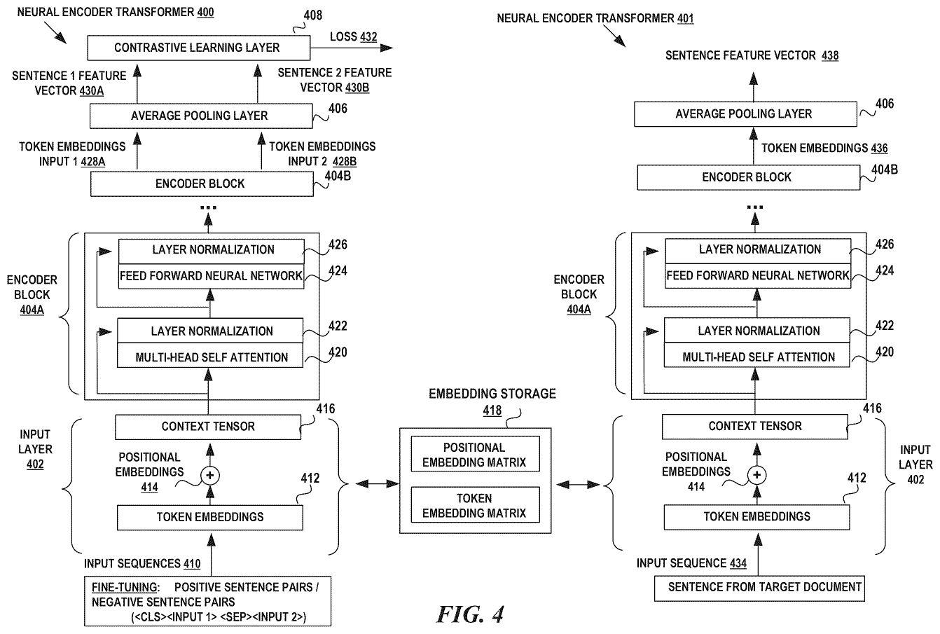

Turning to FIG. 4, there is shown an exemplary configuration of the neural encoder transformer model with attention. There are two configurations of the model with model 400 illustrating the architecture of the model for fine-tuning and model 401 illustrating the architecture of the model when used for inference.

The encoder neural transformer model with attention 400 includes an input layer 402 and one or more encoder blocks 404A-404B. The input layer 402 includes the token embeddings 412 of an input sequence 410 of the training dataset and positional embeddings 414 that represents an order of the tokens in the input sequence. The token embeddings 412 and the positional embeddings 414 are combined to form a context tensor 416.

During fine-tuning, a training sample 410 is tokenized into an input sequence composed of tokens. The tokens in the input sequence are then mapped into respective token embeddings. A positional embedding which contains positional information related to a token embedding is added to the input embedding to form a context tensor. The initial values for the token embedding and positional embeddings are from the pre-trained model and thereafter, the neural encoder transformer model updates the values of the embeddings. Upon the completion of the training phase, the embeddings for each token and the positional embedding are saved for later use.

The input sequences 410 include the positive sentence pairs and the negative sentence pairs. An input sequence of the fine-tuning dataset consists of two sentences which are preceded by a special classification token <CLS> token with each pair, <INPUT 1>, <INPUT 2>, separated by a special separation token<SEP>.

An encoder block 404 consists of two layers. The first layer includes a multi-head self attention component 420 followed by layer normalization component 422. The second layer includes a feed-forward neural network 424 followed by a layer normalization component 426. The context tensor 416 is input into the multi-head self attention layer 420 of the first encoder block 404A with a residual connection to layer normalization 422. The output of the layer normalization 422 is input to the feed forward neural network 424 with another residual connection to layer normalization 426. The output of each encoder block 404 is a set of hidden representations. The set of hidden representations are then sent through additional encoder blocks, if multiple encoder blocks exist.

Attention is used to decide which parts of the input sequence are important for each token. Attention mechanisms gather information about the relevant context of a given token and then encode that context into a vector which represents the token. It is used to identity the relationships between tokens in a long sequence while ignoring other tokens that do not have much bearing on a given prediction.

The multi-head self attention component 420 takes a context tensor 416 and weighs the relevance of each token represented in the context tensor to each other by generating attention weights for each token in the input embedding 412. In one aspect, the attention function is scaled dot-product attention which is described mathematically as follows: Attention

$$( Q , K , V ) = softmax ( \frac{{QK}^{T}}{\sqrt{{d}_{k}}} ) V ,$$

where the input consists of queries Q and keys K of dimension dₖ, and values V of dimension dᵥ. Q is a matrix that contains the query or vector representation of one token in a sequence, K is the vector representations of all tokens in the sequence, and V is the vector representations of all the tokens in the sequence.

The queries, keys and values are linearly projected h times in parallel with dᵥ output values which are concatenated to a final value:

MultiHead (Q, K, V)=Concat (head₁, . . . , headₕ) W^{o},

where headᵢ=Attention (QWᵢ^{Q}, KWᵢ^{K}, VWᵢ^{V}).

The output of the last encoder block contains token embeddings for each of two input sequences. The token embeddings for each respective input sequence are transformed into respective feature vectors 430A, 430B at the average pooling layer 406 by averaging the token embeddings of each input sequence.

The fine-tuning configuration of the model 400 includes a contrastive loss layer 408 which applies a contrastive loss function to the sentence feature vectors 430A, 430B. The contrastive loss function is used to bring similar sentence embeddings closer together in the embedding space and push apart dissimilar sentence embeddings. In an aspect, the contrastive loss function is calculated as a cosine similarity between two sentence vectors 430A, 430B. It then assigns a loss value based on a predefined margin threshold. If the distance between two vectors is less than the margin threshold, the loss value is zero. If the distance is greater than the margin threshold, the loss value is increased.

The contrastive loss function minimizes the following loss objective:

$$ℒ = \{ \begin{matrix}1 - C ( {f}_{p} , {f}_{q} ) , {y}_{p , q} = 1 \\ max ( 0 , C ( {f}_{p} , {f}_{q} ) - ( 1 - m ) ) , {y}_{p , q} = 0 ,\end{matrix}$$

where fₚ and f_{q} are the sentence embeddings of p and q respectively, which are inferred by average pooling the token embeddings output from the last encoder block, where y_{p,q}=1 indicates a positive pair and y_{p,q}=0 indicates a negative pair. The margin is set, m=1, in order to avoid updating the model weights for negative sentence pairs that already have zero or negative similarity. C (fₚ, f_{q}) measures the similarity between fₚ and f_{q} using the Cosine similarity function:

$$C ( {f}_{p} , {f}_{q} ) = \frac{{f}_{p}^{T} {f}_{q}}{\vert {f}_{p} \vert \vert {f}_{q} \vert} ,$$

where fₚ^{T} is the transpose of fₚ.

The neural encoder transformer model is trained iteratively, making multiple passes over the training dataset before converging to a minimum. An epoch represents the entire training dataset passed forwards and backwards through the neural encoder transformer blocks once. Since the training dataset is very large, it is partitioned into smaller batches. The training is iterative and the entire dataset is passed through the neural encoder transformer model in multiple iterations. Each training iteration includes forward propagation, loss calculation, backpropagation steps followed by updating the weights. The training dataset is partitioned into batches with each batch of sequences running through the training process.

The contrastive learning layer 408 computes a loss function that estimates the loss or error 432 which is used to compare how good or bad the predicted results are. Once the loss is calculated, it is propagated backwards to the hidden layer that contributed directly to the output. In backpropagation, the partial derivatives of the loss function with respect to the trainable parameters are determined. The weight gradients are calculated as the difference between the old values and the new values of the weights. The weights are adjusted to make the loss as small as possible using a gradient descent technique.

The configuration of the neural encoder transformer model with attention during inference is shown in neural encoder transformer model 401 which contains some of the layers from the fine-tuned configuration. The model 401 contains the input layer 402, encoder blocks 404, and average pooling layer 406 shown in configuration 400 with the trained weights, biases and embeddings. During the inference phase, the input layer 402 receives an input sequence 434 representing a sentence from a target document for which a topic summary is being generated. The output of the model 401 is the corresponding sentence feature vector 438.

Turning back to FIG. 3, once the model is trained, the model is used to generate sentence embeddings for each sentence in each document (block 306). Paragraphs in each document are known to be related to a particular topic. For the i-th topic that is associated with a set of paragraphs Pⁱ, the sentences of each paragraph are extracted, and each sentence is propagated through the model to generate a corresponding sentence feature vector. This process yields a set of feature vectors, Vⁱ, that represent the distribution of sentences related to the i-th topic.

Next, one or more clusters are formed for each topic to extract anchors representing the distribution of each topic (block 308). In an aspect, the DBSCAN is used to group the feature vectors into clusters by analyzing the density of the feature vectors, grouping high-density regions into a cluster, and marking feature vectors in low density areas as outliers. The center of each cluster is extracted and used as an anchor. The set of anchors for topic tᵢ is denoted by Aⁱ={a₁ⁱ, . . . , aₗⁱ}, where lⁱ is the number of clusters.

Once the anchors are computed, a target document and topics are obtained (block 310). The document is partitioned into sentences and each sentence is propagated through the neural encoder transformer model to generate a respective sentence feature vector (block 312).

A graph is then generated for each topic (blocks 314, 316). The graph Gᵢ is a directed graph for topic i with a set of nodes and a set of edges. Each node represents a sentence in the document and has an edge weight w(q,p) for the edge between nodes q and p. The graph creation engine utilizes the topic clusters and anchors previously computed to determine the edge weight of each edge in the graph as follows:

w_{q,p}=C (SE (q)), SE(p))*A(q, tᵢ)*A(p, tᵢ),

where SE (q) is the feature vector for sentence q output from the neural encoder model, SE(p) is the feature vector for sentence p output from the neural encoder model, C is the cosine similarity function, tᵢ is the given topic, A (q, tᵢ) is the sentence-topic similarity function for sentence q and topic tᵢ, A (p, tᵢ) is the sentence-topic similarity function for sentence p and topic tᵢ, as defined above.

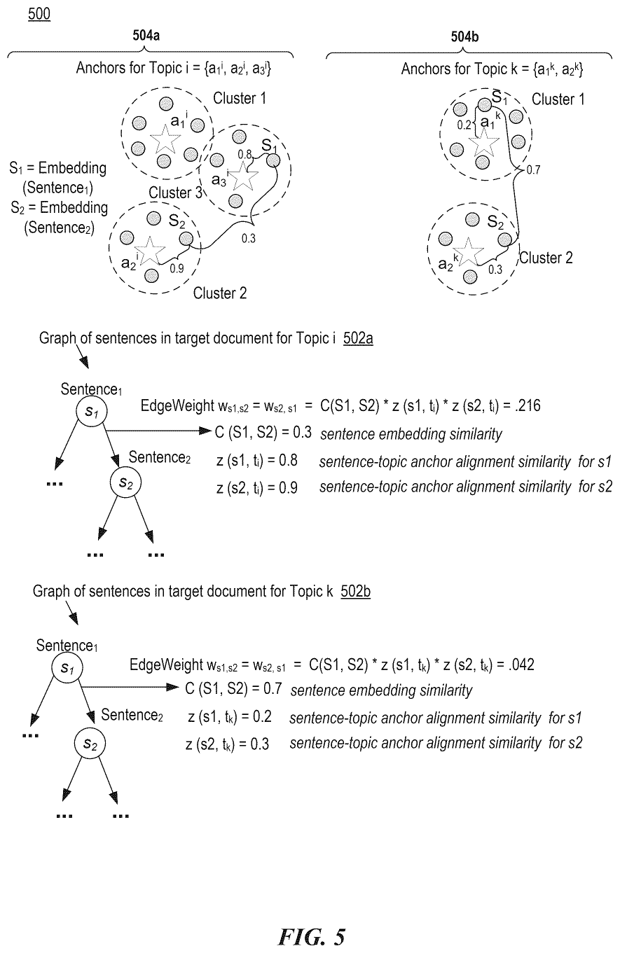

Turning to FIG. 5, there is shown an exemplary depiction of the edge weight calculations. FIG. 5 shows a graph for topic i 502a and a graph for topic k 502b. Each graph contains a node representing Sentence 1 connected to a node for Sentence 2. Also shown are the clusters and anchors associated with topic i, 504a and the clusters and anchors associated with topic k, 504b.

In each graph, 502a, 502b, the edge weight for the edge connecting the node for Sentence 1 to the node for Sentence 2 consists of three scores: (i) the cosine similarity between two sentence embeddings; (ii) the final similarity score between the sentence embedding for Sentence 1 and its closest anchor, computed as shown above using equation (3); and (iii) the final similarity score between the sentence embedding for Sentence 2 and its closest anchor computed as above using equation (3). The final similarity score for a node is then converted into a probability using the softmax function of equation (2) above.

Turning back to FIG. 3, each graph is traversed iteratively to compute a score for each node in a particular graph that represents the importance of the node with respect to the given topic (block 316). In an aspect, the score S for node n of each graph is computed as follows:

$$S ( {V}_{i} ) = ( 1 - d ) + d * {\sum }_{Vj ∈ G . In ( Vi )} \frac{wji}{{\sum }_{Vk ∈ G . Out ( Vj )} wjk} S ( Vj ) .$$

where Vᵢ is a node in the graph Gᵢ,

d is a damping factor residual probability set to 0.85,

Vⱼ is a node having an incoming edge to node Vᵢ,

Vₖ is a node having an outgoing edge from node Vⱼ,

G.In is the set of nodes having edges incoming to node Vᵢ,

G.Out is the set of nodes having edges outgoing from node Vⱼ,

wⱼᵢ is the edge weight from node Vⱼ to node Vᵢ computed using equation (1) above,

wⱼₖ is the edge weight from node Vⱼ to node Vₖ computed using equation (1) above, and

S(Vⱼ) is the score of the node Vⱼ.

The score for a sentence is based on the nodes having an incoming edge, Vⱼ, to the sentence being scored, Vᵢ. The score for each node having an incoming edge, S(Vⱼ), is adjusted by the ratio of the edge weight of the incoming edge to the sentence being scored wⱼᵢ over the sum of all the edge weights of the outgoing edges of the node having the incoming edge to the sentence being scored, Σ_{Vk∈G.Out(Vj)}wjk.

Each graph is traversed starting from a random node and the traversal follows each edge from each node. As each node Vᵢ is visited, the score of the node, S(Vᵢ) is computed. This process iterates until the scores converge within a specified tolerance. (Blocks 318-320).

The sentences are then sorted by descending score (block 322) and used to identify the top-k highest scoring sentences for each topic, where k in a user-defined value (block 322). The top-k highest scoring sentences are then sorted by appearance in the document (block 324) and output in the topic summary (block 326).

### Exemplary Applications

Attention now turns to a description of exemplary applications employing the topic-conditional extractive summarization system.

There are many applications of the topic-conditional extractive summarization system including, but not limited to, generating topic summaries, organizing documents with multiple themes, generating topic-specific recommendation lists for articles, generating tailored summaries to readers based on their interests and assisting users in quickly identifying relevant information from a large corpus of documents, summarizing emails, etc.

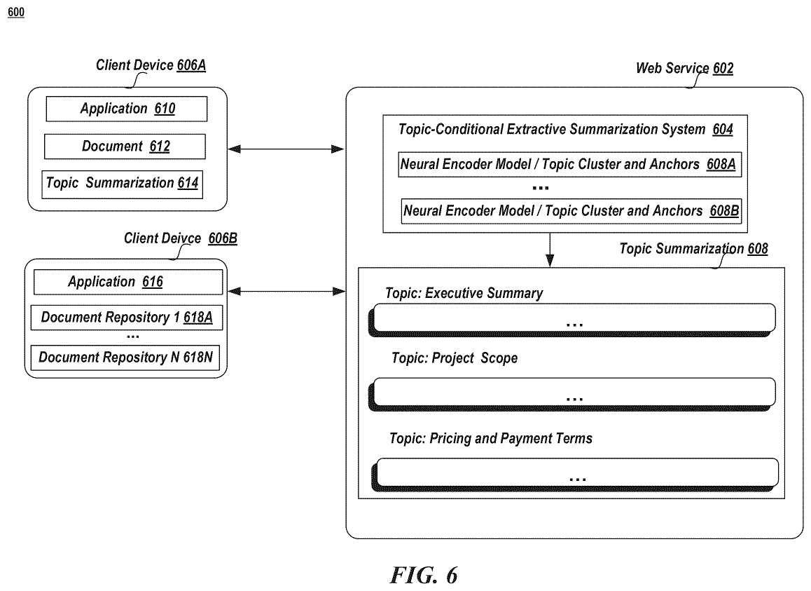

In an aspect, the topic-conditional extractive summarization system is hosted as a web service to facilitate the topic summarization for a particular application. Turning to FIG. 6, there is shown an exemplary web service 602 hosting the topic-conditional extractive summarization system 604 to interact through a network, such as the Internet, with various client devices 606A, 606B. The web service 602 comprises the topic-conditional extractive summarization system 604 to perform topic summarization for the various applications 610, 616 and includes the pre-configured neural encoder models, topics, and associated clusters and anchors for each application 608A-608B.

In an aspect, the web service 602 may be part of a Customer Relationship Management (CRM) or Enterprise Resource Planning (ERP) application 610 which manages the data and interactions between existing and prospective customers of a company. In this example, the web service 602 receives a request for a topic summarization for a 62-page business document 612 and the topics of interest, such as an executive summary, a project scope and payment and pricing terms of the 62-page business document. The web service 602 invokes the topic-conditional extractive summarization system to generate the requested topic summarizations 614 which is returned to the requesting client device 606A.

Alternatively, the web service 602 may be part of a distributed version control application 616, such as GitHub, which monitors changes to various documents shared by multiple users. In this example, the web service 602 receives a request to perform a topic summarization for a particular document stored in the various document repositories 618A-618N of the distributed version control system.

In another aspect, the web service 602 may be part of a large call center receiving numerous customer calls for service. These calls are recorded and transcribed into lengthy documents that cover a variety of topics for which a topic summary is needed. The web service 602 receives a request to perform the topic summarization for the transcribed documents.

### Operating Environments

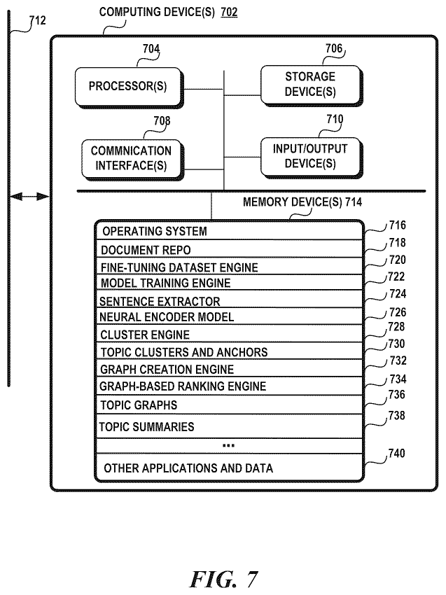

Attention now turns to a discussion of the exemplary operating environments. FIG. 7 illustrates a first exemplary operating environment 700 having at least one computing device 702 communicatively coupled to a network 712.

The computing device 702 may be any type of electronic device, such as, without limitation, a mobile device, a personal digital assistant, a mobile computing device, a smart phone, a cellular telephone, a handheld computer, a server, a server array or server farm, a web server, a network server, a blade server, an Internet server, a work station, a mini-computer, a mainframe computer, a supercomputer, a network appliance, a web appliance, a distributed computing system, multiprocessor systems, or combination thereof. The operating environment 500 may be configured in a network environment, a distributed environment, a multi-processor environment, or a stand-alone computing device having access to remote or local storage devices.

A computing device 702 may include one or more processors 704, one or more storage devices 706, one or more communication interfaces 708, one or more input/output devices 710, and one or more memory devices 714. A processor 704 may be any commercially available or customized processor and may include dual microprocessors and multi-processor architectures. A communication interface 708 facilitates wired or wireless communications between the computing device 702 and other devices. A storage device 706 may be computer-readable medium that does not contain propagating signals, such as modulated data signals transmitted through a carrier wave. Examples of a storage device 706 include without limitation RAM, ROM, EEPROM, flash memory or other memory technology, CD-ROM, digital versatile disks (DVD), or other optical storage, magnetic cassettes, magnetic tape, magnetic disk storage, all of which do not contain propagating signals, such as modulated data signals transmitted through a carrier wave. There may be multiple storage devices 706 in a computing device 702. The input/output devices 710 may include a keyboard, mouse, pen, voice input device, touch input device, display, speakers, printers, etc., and any combination thereof.

A memory device 714 may be any non-transitory computer-readable storage media that may store executable procedures, applications, and data. The computer-readable storage media does not pertain to propagated signals, such as modulated data signals transmitted through a carrier wave. It may be any type of non-transitory memory device (e.g., random access memory, read-only memory, etc.), magnetic storage, volatile storage, non-volatile storage, optical storage, DVD, CD, floppy disk drive, etc. that does not pertain to propagated signals, such as modulated data signals transmitted through a carrier wave. A memory device 714 may also include one or more external storage devices or remotely located storage devices that do not pertain to propagated signals, such as modulated data signals transmitted through a carrier wave.

The memory device 714 may contain instructions, components, and data. A component is a software program that performs a specific function and is otherwise known as a module, program, component, and/or application. The memory device 714 may include an operating system 716, a document repository (repo) 718, fine-tuning dataset engine 720, model training engine 722, sentence extractor 724, neural encoder model 726, cluster engine 728, topic clusters and anchors 730, graph creation engine 732, graph-based ranking engine 734, topic graphs 736, topic summaries 738, and other applications and data 740.

A computing device 702 may be communicatively coupled via a network 712. The network 712 may be configured as an ad hoc network, an intranet, an extranet, a virtual private network (VPN), a local area network (LAN), a wireless LAN (WLAN), a wide area network (WAN), a wireless WAN (WWAN), a metropolitan network (MAN), the Internet, a portion of the Public Switched Telephone Network (PSTN), plain old telephone service (POTS) network, a wireless network, a WiFi® network, or any other type of network or combination of networks.

The network 712 may employ a variety of wired and/or wireless communication protocols and/or technologies. Various generations of different communication protocols and/or technologies that may be employed by a network may include, without limitation, Global System for Mobile Communication (GSM), General Packet Radio Services (GPRS), Enhanced Data GSM Environment (EDGE), Code Division Multiple Access (CDMA), Wideband Code Division Multiple Access (W-CDMA), Code Division Multiple Access 2000, (CDMA-2000), High Speed Downlink Packet Access (HSDPA), Long Term Evolution (LTE), Universal Mobile Telecommunications System (UMTS), Evolution-Data Optimized (Ev-DO), Worldwide Interoperability for Microwave Access (WiMax), Time Division Multiple Access (TDMA), Orthogonal Frequency Division Multiplexing (OFDM), Ultra Wide Band (UWB), Wireless Application Protocol (WAP), User Datagram Protocol (UDP), Transmission Control Protocol/Internet Protocol (TCP/IP), any portion of the Open Systems Interconnection (OSI) model protocols, Session Initiated Protocol/Real-Time Transport Protocol (SIP/RTP), Short Message Service (SMS), Multimedia Messaging Service (MMS), or any other communication protocols and/or technologies.

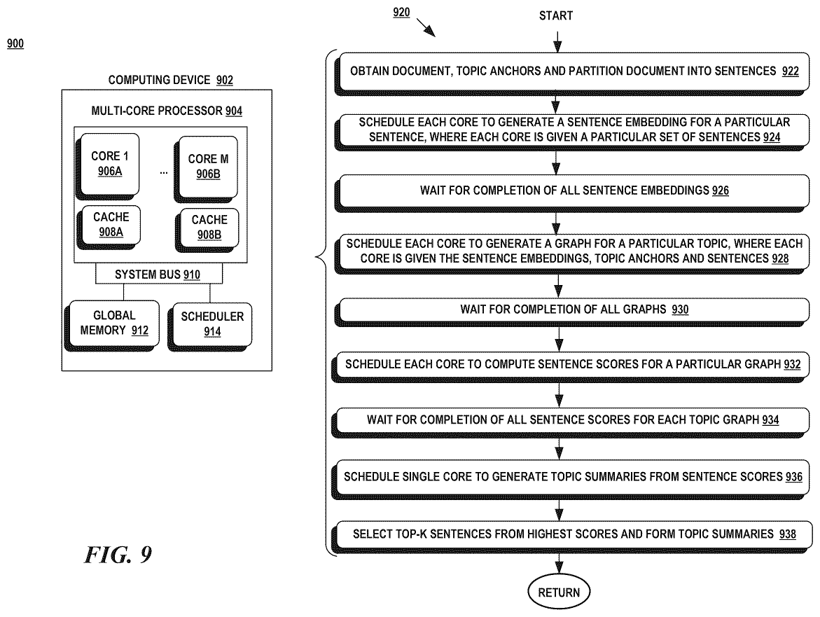

FIG. 9 illustrates a second exemplary operating environment 900. In this operating environment 900, the inference phase of the topic extractive summarization system executes on a computing device 902 having multiple multi-core processors 904A-904N. A multi-core processor is a microprocessor on a single integrated circuit with two or more separate processing units, called cores, 906A-906D, each of which reads and executes program instructions. Each core has a dedicated local memory or cache 908A-908D. The multi-core processors 904A-904N are connected via a system bus 910 to a global memory 912. A scheduler 914 is communicatively coupled to the multi-core processors 904A-904N which creates and schedules threads to perform specific tasks on each of the cores 906A-906D. The computing device 902 includes other components, such as a communication interface, storage devices, and input and output devices not shown.

In an aspect, a method 920 operates on the multi-core processor 904 to perform the inference phase 204 shown in FIG. 2. The method is given a document, topic clusters with anchors, and neural encoder model. The scheduler 914 extracts the sentences from the document (block 922) and schedules a thread for each core to generate a sentence embedding for one or more sentences (block 924). The sentence embedding may be stored in the global memory 912. There may not be enough cores to generate each sentence embedding simultaneously when the number of cores is then than the number of sentences. In this case, the scheduler 914 assigns each core with a particular set of sentences for the core to generate the corresponding sentence embeddings. The neural encoder model is distributed in the cache of each core.

When all the sentence embeddings are generated (block 926), the scheduler creates a thread for each core, where the thread includes instruction for the core to generate a respective topic graph given all the sentence embeddings (block 928). Upon completion of the generation of all the topic graphs (block 930), the scheduler creates a thread for each core, where the thread includes instructions for the core to generate a score for each sentence in a particular topic graph (block 932). The topic graphs may be stored in global memory 912 or in the core's cache 908.

When all the sentence scores in each topic graph are calculated (block 934), the scheduler creates a single thread for a single core to rank the sentences in descending score order, to take the top-k sentences for each topic, sort the top-k sentences in order of appearance and form the topic summaries (block 936). The topic summaries are then output as described above (block 938).

### Technical Effect

Aspects of the subject matter disclosed pertain to the technical problem of identifying the most relevant sentences of a document that pertain to a given topic in order to generate a topic-conditional extractive summary of the document. A topic extractive summarization is a shortened version of a lengthy document that describes the topics of interest using sentences extracted from the document. The technical features associated with addressing this problem is an unsupervised approach, developed without ground truth summaries, that utilizes a neural encoder model to generate clusters of similar sentence embeddings and associated anchors for each topic and a graph-based ranking method that identifies the most pertinent sentences for a topic using several similarity factors based on the anchors and sentence embeddings. The technical effect that is achieved is the reduction of computing resources used to generate a readable, coherent, and accurate topic summarization.

In other aspects, the subject matter disclosed pertains to the encoding of a linguistic algorithm such that it operates particularly efficiently on a multi-core processor. The multi-core processor to able to generate sentence embeddings for each sentence of a document in parallel, generate graphs for each topic of the topic summarization in parallel, and compute a score for each sentence with respect to each topic in parallel. In this manner, the technique executes more code and data efficiently thereby improving the functioning of the computer.

### Performance Improvements

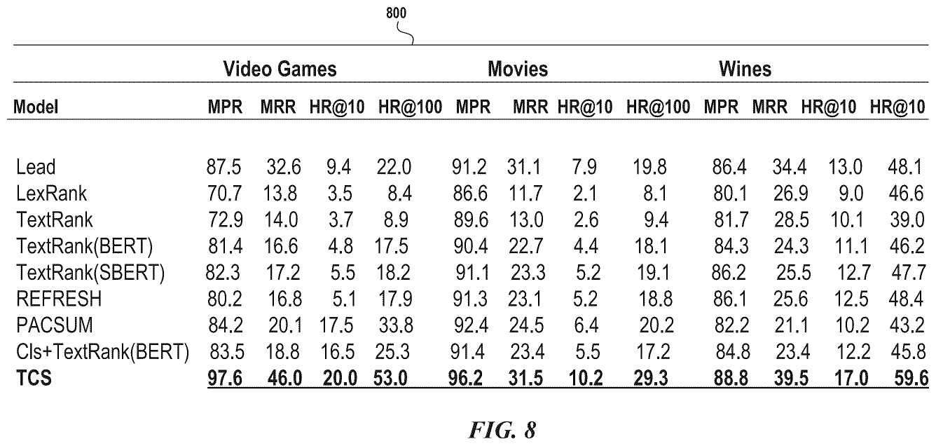

FIG. 8 illustrates the results of an evaluation of the topic-conditional extractive summarization system with respect to prior solutions. The techniques described herein are an improvement over prior solutions. FIG. 8 depicts a table 800 showing a comparison of the topic-conditional extractive summarizations system (“TCS”) with other models on three datasets of long documents with multiple topics, namely Video Games, Movies, and Wine. The Video Games dataset contains 21,935 articles reviewing various video games of direct genres and platforms, discussing different topics. The Movie dataset is based on movie articles extracted from Wikipedia. The Wine dataset contains 1635 articles from the wine domain discussing different wine categories, wineries, brands, grape varieties, and more. These datasets are not supplied with ground truth summarization labels.

The similarity accuracy was tested against the following models: Lead; LexRank; TextRank; TextRank (BERT); TextRank (SBERT); REFRESH; PACSUM; and Cls+TextRank (BERT).

Lead is a naïve baseline that retrieves the first sentences of paragraphs as a summary. LexRank is a text summarization technique that uses a graph representation of the sentences, where the edges are based on Term Frequency-Inverse Document Frequency (TF-IDF) and the cosine similarity between the representations. TextRank is a graph-based ranking method where a connection between two sentences is based on a function of their content overlap, such as a number of common tokens between the two sentences. TextRank (BERT) uses a BERT model to build the graph where the weights of the edges are based on the similarity between the BERT embeddings. TextRank (SBERT) uses SBERT embeddings computed from a Siamese BERT and triplet network.

REFRESH is a supervised method that utilizes a hierarchical encoder-decoder model to extract summaries that is optimized via reinforcement learning. PACSUM uses BERT embeddings to infer sentence similarity and sets the edge weights to incorporate the relative position of sentences in a document. Cls+TextRank (BERT) uses a BERT-based classification model, that splits each document into sub-documents, and retrieves the top sentences of each sub-document.

The similarity accuracy was measured using multiple metrics: (1) Mean Percentile Rank (MPR); (2) Mean Reciprocal Rank (MRP); (3) Hit Ratio at 10 (HR@10); and (4) Hit Ratio at 100 (HR@100). The MPR is the average of the percentile ranks for every sample with ground truth similarities in the dataset. Given a sample s, the percentile rank for a true recommendation r is the rank the model gave to r divided by the number of samples in the dataset. MRR is the average of the best reciprocal ranks for every sample with ground truth similarities in the dataset. For a given sample with a ground truth similarity, the rank of the ground truth similarity of the model and then take the reciprocal of the best or lowest rank. Hit Ratio at 10 evaluates the percentage of true predictions in the top-10 retrievals made by the model. Hit Ratio at 100 evaluate the percentage of true predictions in the top-100 retrievals made by the model.

As seen in the table shown in FIG. 8, the topic-conditional extractive summarization system outperforms the other prior solutions by a sizable margin. This is attributable to the fact that the system generates multiple summaries for different topics allowing for greater coverage while maintaining sentences that correspond to the main essence of each document thereby reinforcing the summaries to conform to the main identity of the document. Specifically, the poor performance of Cls+TextRank (BERT) indicates a limited ability of the technique to preserve sentences that correlate with the main essence of the entire document. By applying a vanilla TextRank on a set of sentences of the same topic, Cls+TextRank (BERT) retrieves sentences that only maximize the centrality with respect to the topic at hand, ignoring central information that can appear across the entire document.

### CONCLUSION

One of ordinary skill in the art understands that the techniques disclosed herein are inherently digital. The operations used to train the neural encoder transformer model with attention on similar sentences to generate an embedding space used to form clusters and the anchors for a topic are inherently digital and cannot be performed in the human mind. The operations used to generate the graph, to compute the edge weights for each edge of the graph, to score each node in the graph in the manner described above, and to search for the most relevant sentences based on the graph are inherently digital and cannot be performed in the human mind. The human mind cannot interface directly with a CPU or network interface card, or other processor, or with RAM or other digital storage, to read or write the necessary data and perform the necessary operations disclosed herein.

The embodiments are also presumed to be capable of operating at scale, within tight timing constraints in production environments and in testing labs for production environments as opposed to being mere thought experiments. Hence, the human mind cannot perform the operations described herein in a timely manner and with the accuracy required for the intended uses.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

It may be appreciated that the representative methods described herein do not necessarily have to be executed in the order presented, or in any particular order, unless otherwise indicated. Moreover, various activities described with respect to the methods can be executed in serial or parallel fashion, or any combination of serial and parallel operations.

A system is disclosed for generating a topic-conditional extractive summarization of a document, comprising: a processor; and a memory that stores a program that is configured to be executed by the processor, the program includes instructions to perform actions that: obtain a request to generate the topic-conditional extractive summarization for the document for a given topic, wherein the document comprises a plurality of sentences; obtain a plurality of clusters of sentence feature vectors for each of a plurality of topics, each cluster of the plurality of clusters associated with a given topic comprises an anchor representing a center of a cluster; and search for sentences of the document that pertain to the given topic, wherein the search includes instructions to perform action that: generate a graph of the document for each topic, wherein each graph comprises a plurality of nodes and a plurality of edges, wherein a node represents a sentence of the plurality of sentences of the document, wherein an edge connects two nodes and comprises an edge weight, wherein the edge weight comprises a sentence embedding similarity factor and a sentence-topic anchor alignment factor for each of the two connected nodes, wherein the sentence embedding similarity factor is based on a similarity between the sentence feature vectors of the sentences of the two connected nodes of an edge, wherein the sentence-topic anchor alignment factor is based on similarity between the sentence feature vector of each of the two connected nodes and a closest anchor associated with a particular topic; iteratively traverse each node in each graph to generate a score for each node, wherein the score represents importance of a node with respect to a select topic; and select sentences from top-k nodes having highest scores for the topic summary.

In an aspect, the program includes instructions to perform actions that: sort the selected sentences having highest scores by descending score. In an aspect, the program includes instructions to perform actions that: output the selected sentences in the topic summary in a same position as each selected sentence appears in the document. In an aspect, the sentence-topic anchor alignment factor is based on a similarity between a sentence feature vector of a sentence and a closest one of the anchors associated with the topic. In an aspect, the sentence-topic anchor alignment factor is normalized with respect to a cluster size of the closest one of the anchors associated with the topic.

In an aspect, the score for each node in the graph is based on a score of the connected nodes and edge weights of the connected nodes. In an aspect, the plurality of clusters is generated from sentence vectors formed from a neural encoder model. In an aspect, the neural encoder model is trained to generate sentence feature vectors by contrasting similar sentence pairs and dissimilar sentence pairs.

A computer-implemented method is disclosed for generating a topic summarization of a document, comprising: obtaining a plurality of topics for the topic summarization; obtaining one or more anchors of each of the plurality of topics, wherein an anchor represents a center of a cluster of feature vectors associated with a particular topic; partitioning the document into a plurality of sentences; generating a feature vector for each sentence of the plurality of sentences; creating a graph for each topic, wherein the graph comprises a node for each sentence and an edge that connects two nodes, wherein an edge comprises an edge weight, wherein the edge weight comprises a sentence embedding similarity factor and a sentence-topic anchor alignment factor for each of the two connected nodes, wherein the sentence embedding similarity factor is based on a similarity between the feature vectors of the sentences of the two connected nodes of the edge, wherein the sentence-topic anchor alignment factor is based on similarity between the feature vector of the sentence of a node and a closest anchor associated with the topic associated with a respective graph; iteratively traversing each graph to compute a score for each node, wherein the score represents relevance of the sentence of the node to the topic, wherein the score is based on the edge weights of connected nodes and the score of the connected nodes; and selecting sentences from top-k nodes having highest scores for the topic summary.

In an aspect, the computer-implemented method further comprises: sorting the selected sentences from the top-k nodes having highest scores by descending score. In an aspect, the computer-implemented method further comprises: outputting the selected sentences in the topic summary in a same position as each selected sentence appears in the document. In an aspect, the computer-implemented method further comprises: computing the sentence embedding similarity factor as a cosine similarity between the feature vectors of the sentences of two connected nodes. In an aspect, the computer-implemented method further comprises: computing the sentence-topic anchor alignment factor for a first node having an edge with a second node, wherein the sentence-topic anchor alignment factor of the sentence of the first node represents a cosine similarity of the sentence embedding of the sentence of the first node with the closest anchor for the topic normalized by the cluster size of the cluster of the closest anchor.

In an aspect, the computer-implemented method further comprises: computing the sentence-topic anchor alignment factor for the second node, wherein the sentence-topic anchor alignment factor of the sentence of the second node represents a cosine similarity of the sentence embedding of the sentence of the second node with the closest anchor for the topic normalized by the cluster size of the cluster of the closest anchor. In an aspect, the computer-implemented method further comprises: generating the feature vector for each sentence using a neural encoder model, wherein the neural encoder model is trained through contrastive learning on positive sentence pairs and negative sentence pairs.

A system is disclosed for generating a topic-conditional extractive summarization of a document, comprising: a multi-core processor comprising a plurality of cores; and a memory that stores a program that is configured to be executed by at least one core, the program includes instructions to perform actions that: receive the document and a plurality of topics; generate a sentence embedding for each sentence of the document, wherein each core of the plurality of cores generates one or more of the sentence embeddings in parallel with other cores of the plurality of cores; generate a graph for each of the plurality of topics, wherein each graph is generated by a select core of the plurality of cores in parallel with the other cores, wherein a graph comprises a node for each sentence and an edge that connects two nodes, wherein an edge comprises an edge weight, wherein the edge weight comprises a sentence embedding similarity factor and a sentence-topic anchor alignment factor for each of the two connected nodes, wherein the sentence embedding similarity factor is based on a similarity between the feature vectors of the sentences of the two connected nodes of the edge, wherein the sentence-topic anchor alignment factor is based on similarity between the feature vector of the sentence of a node and a closest anchor associated with the topic; compute a score for each sentence of each of the plurality of graphs, wherein the score represents relevance of a respective sentence to a particular topic, wherein the score is based on the edge weights of connected nodes and a corresponding score of the connected nodes, wherein the score for each sentence of each graph is generated by a select core of the plurality of cores in parallel with the other cores; and select sentences having highest scores for a particular topic for the topic summary.

In an aspect, the program includes instructions to perform actions that: sort the selected sentences having highest scores for a particular topic by descending score; and output the selected sentences in the topic summary in a same position as each selected sentence appears in the document.

In an aspect, the sentence embedding similarity factor comprises a cosine similarity between the feature vectors of the sentences of two connected nodes. In an aspect, the sentence-topic anchor alignment factor is based on a similarity between a sentence feature vector of a sentence and a closest one of the anchors associated with the topic. In an aspect, the score for a select node in a select graph is based on scores of a particular node having an incoming edge to the select node, wherein the score of the particular node having an incoming edge is adjusted by a proportion of edge weights of outgoing edges from the particular node having the incoming edge to the select node.

What is claimed:

1. A system for generating a topic-conditional extractive summarization of a document, comprising:
a processor; and
a memory that stores a program that is configured to be executed by the processor, the program includes instructions to perform actions that:
obtain a request to generate the topic-conditional extractive summarization for the document for a given topic, wherein the document comprises a plurality of sentences;
obtain a plurality of clusters of sentence feature vectors for each of a plurality of topics, each cluster of the plurality of clusters associated with a given topic comprises an anchor representing a center of a cluster; and
search for sentences of the document that pertain to the given topic, wherein the search includes instructions to perform action that:
generate a graph of the document for each topic, wherein each graph comprises a plurality of nodes and a plurality of edges, wherein a node represents a sentence of the plurality of sentences of the document, wherein an edge connects two nodes and comprises an edge weight, wherein the edge weight comprises a sentence embedding similarity factor and a sentence-topic anchor alignment factor for each of the two connected nodes, wherein the sentence embedding similarity factor is based on a similarity between the sentence feature vectors of the sentences of the two connected nodes of an edge, wherein the sentence-topic anchor alignment factor is based on similarity between the sentence feature vector of each of the two connected nodes and a closest anchor associated with a particular topic;
iteratively traverse each node in each graph to generate a score for each node, wherein the score represents importance of a node with respect to a select topic; and
select sentences from top-k nodes having highest scores for the topic summary.

2. The system of claim 1, wherein the program includes instructions to perform actions that:
sort the selected sentences having highest scores by descending score.

3. The system of claim 2, wherein the program includes instructions to perform actions that:
output the selected sentences in the topic summary in a same position as each selected sentence appears in the document.

4. The system of claim 1, wherein the sentence-topic anchor alignment factor is based on a similarity between a sentence feature vector of a sentence and a closest one of the anchors associated with the topic.

5. The system of claim 4, wherein the sentence-topic anchor alignment factor is normalized with respect to a cluster size of the closest one of the anchors associated with the topic.

6. The system of claim 1, wherein the score for each node in the graph is based on a score of the connected nodes and edge weights of the connected nodes.

7. The system of claim 1, wherein the plurality of clusters is generated from sentence vectors formed from a neural encoder model.

8. The system of claim 7, wherein the neural encoder model is trained to generate sentence feature vectors by contrasting similar sentence pairs and dissimilar sentence pairs.

9. A computer-implemented method for generating a topic summarization of a document, comprising:
obtaining a plurality of topics for the topic summarization;
obtaining one or more anchors of each of the plurality of topics, wherein an anchor represents a center of a cluster of feature vectors associated with a particular topic;
partitioning the document into a plurality of sentences;
generating a feature vector for each sentence of the plurality of sentences;
creating a graph for each topic, wherein the graph comprises a node for each sentence and an edge that connects two nodes, wherein an edge comprises an edge weight, wherein the edge weight comprises a sentence embedding similarity factor and a sentence-topic anchor alignment factor for each of the two connected nodes, wherein the sentence embedding similarity factor is based on a similarity between the feature vectors of the sentences of the two connected nodes of the edge, wherein the sentence-topic anchor alignment factor is based on similarity between the feature vector of the sentence of a node and a closest anchor associated with the topic associated with a respective graph;
iteratively traversing each graph to compute a score for each node, wherein the score represents relevance of the sentence of the node to the topic, wherein the score is based on the edge weights of connected nodes and the score of the connected nodes; and
selecting sentences from top-k nodes having highest scores for the topic summary.

10. The computer-implemented method of claim 9, further comprising:
sorting the selected sentences from the top-k nodes having highest scores by descending score.

11. The computer-implemented method of claim 9, further comprising:
outputting the selected sentences in the topic summary in a same position as each selected sentence appears in the document.

12. The computer-implemented method of claim 9, further comprising:
computing the sentence embedding similarity factor as a cosine similarity between the feature vectors of the sentences of two connected nodes.

13. The computer-implemented method of claim 9, further comprising:
computing the sentence-topic anchor alignment factor for a first node having an edge with a second node, wherein the sentence-topic anchor alignment factor of the sentence of the first node represents a cosine similarity of the sentence embedding of the sentence of the first node with the closest anchor for the topic normalized by the cluster size of the cluster of the closest anchor.

14. The computer-implemented method of claim 13, further comprising:
computing the sentence-topic anchor alignment factor for the second node, wherein the sentence-topic anchor alignment factor of the sentence of the second node represents a cosine similarity of the sentence embedding of the sentence of the second node with the closest anchor for the topic normalized by the cluster size of the cluster of the closest anchor.

15. The computer-implemented method of claim 9, further comprising:
generating the feature vector for each sentence using a neural encoder model, wherein the neural encoder model is trained through contrastive learning on positive sentence pairs and negative sentence pairs.

16. A system for generating a topic-conditional extractive summarization of a document, comprising:
a multi-core processor comprising a plurality of cores; and
a memory that stores a program that is configured to be executed by at least one core, the program includes instructions to perform actions that:
receive the document and a plurality of topics;
generate a sentence embedding for each sentence of the document, wherein each core of the plurality of cores generates one or more of the sentence embeddings in parallel with other cores of the plurality of cores;
generate a graph for each of the plurality of topics, wherein each graph is generated by a select core of the plurality of cores in parallel with the other cores, wherein a graph comprises a node for each sentence and an edge that connects two nodes, wherein an edge comprises an edge weight, wherein the edge weight comprises a sentence embedding similarity factor and a sentence-topic anchor alignment factor for each of the two connected nodes, wherein the sentence embedding similarity factor is based on a similarity between the feature vectors of the sentences of the two connected nodes of the edge, wherein the sentence-topic anchor alignment factor is based on similarity between the feature vector of the sentence of a node and a closest anchor associated with the topic;
compute a score for each sentence of each of the plurality of graphs, wherein the score represents relevance of a respective sentence to a particular topic, wherein the score is based on the edge weights of connected nodes and a corresponding score of the connected nodes, wherein the score for each sentence of each graph is generated by a select core of the plurality of cores in parallel with the other cores; and
select sentences having highest scores for a particular topic for the topic summary.

17. The system of claim 16, wherein the program includes instructions to perform actions that:
sort the selected sentences having highest scores for a particular topic by descending score; and
output the selected sentences in the topic summary in a same position as each selected sentence appears in the document.

18. The system of claim 16, wherein the sentence embedding similarity factor comprises a cosine similarity between the feature vectors of the sentences of two connected nodes.

19. The system of claim 16, wherein the sentence-topic anchor alignment factor is based on a similarity between a sentence feature vector of a sentence and a closest one of the anchors associated with the topic.

20. The system of claim 16, wherein the score for a select node in a select graph is based on scores of a particular node having an incoming edge to the select node, wherein the score of the particular node having an incoming edge is adjusted by a proportion of edge weights of outgoing edges from the particular node having the incoming edge to the select node.
